(19) United States
(12) Patent Application Publication
(10) Pub. No.: US 2009/0210709 A1
(43) Pub. Date: Aug. 20, 2009

(54) CONTENT TRANSMITTING AND RECEIVING SYSTEM

(75) Inventors: Yoshinobu FUJIWARA, Kanagawa (JP); Tatsuyuki Matsushita, Tokyo (JP); Hiroshi Isozaki, Kanagawa (JP); Kunio Honsawa, Tokyo (JP); Kazunobu Konda, Tokyo (JP); Chikara Ushimaru, Tokyo (JP); Yoshihisa Kizuka, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 12/332,858

(22) Filed: Dec. 11, 2008

(30) Foreign Application Priority Data
Feb. 18, 2008 (JP) 2008-036442

(51) Int. Cl. H04L 9/06; H04N 7/167; H04L 9/08

(52) U.S. Cl. 713/171; 380/217; 380/278

(57) ABSTRACT

A transmitting apparatus transmits, to a receiving apparatus, a content that contains at least, in the stated order, a first portion that is encrypted with a shared key shared between the transmitting apparatus and the receiving apparatus, a second portion that is not encrypted, and a third portion that is encrypted with the shared key. In this situation, in the case where the encrypted third portion has become a transmission target after the second portion has been transmitted, and also, there is a possibility that the shared key stored in the receiving apparatus may be invalidated when the encrypted third portion is received, the transmitting apparatus sequentially transmits a fourth portion and the encrypted third portion to the receiving apparatus, the fourth portion containing at least element data that belongs to the last group in the second portion.

### CROSS-REFERENCE TO RELATED APPLICATIONS

This application is based upon and claims the benefit of priority from the prior Japanese Patent Application No. 2008-36442, filed on Feb. 18, 2008; the entire contents of which are incorporated herein by reference.

### BACKGROUND OF THE INVENTION

1. Field of the Invention

The present invention relates to a transmitting apparatus that transmits contents, a receiving apparatus that receives contents, a content transmitting and receiving system, a content transmitting method, a content receiving method, and a computer program product therefor.

2. Description of the Related Art

In recent years, as computer networks such as broadband networks and wireless Local Area Networks (LANs) have become more widely used, digital information devices and digital home appliances having communication functions have grown popular. In addition, televisions, set-top boxes, and Digital Versatile Disk (DVD) recorders that are compliant with digital broadcasts will grow more popular, too. By having these digital information devices connected to networks, the users will be able to enjoy contents via the networks.

Generally speaking, contents include various types of digital data such as moving-picture data and audio data like Moving Picture Experts Group (MPEG) 2 and MPEG 4 as well as document data like text data and image data. Contents made of digital data have an advantageous characteristic where they can be easily copied without degradation of quality. However, care should be taken regarding the copyrights of the contents.

For example, a system has been proposed in which contents of which the copyrights should be protected are transmitted and received between a transmitting apparatus and a receiving apparatus via a network. In this system, copy control information is attached to the contents of which the copyright should be protected so that copying and transferring (hereinafter, “moving”) of the contents are controlled according to the copy control information. There are different types of copy control information such as “No more copies”, “Copy free”, “Copy never”, and “Copy one generation”. “No more copies” means that no more copies of the contents are permitted, but moving of the contents is permitted. “Copy free” means that copying and moving are both permitted. “Copy never” means that copying and moving are both prohibited. “Copy one generation” means that copying of only one generation is permitted. When contents to which the copy control information “Copy one generation” is attached are recorded once, the copy control information is changed to “No more copies”.

For example, there are various methods for moving contents to which the copy control information “No more copies” is attached while protecting the copyrights thereof. For instance, one of the methods can be implemented in the following three steps:

(1) A transmitting apparatus and a receiving apparatus perform an authentication and key exchange process with each other;
(2) Copy the contents from the transmitting apparatus onto the receiving apparatus, after causing the contents to be in an “unusable state”. In this situation, the transmitting apparatus stores therein the contents that are in a “usable state”; and
(3) Cause the contents in the “usable state” stored in the transmitting apparatus to be in an “unusable state”, and cause the contents in the “unusable state” stored in the receiving apparatus to be in a “usable state”.

This process will be referred to as a process for moving the right to use for the contents, or a “right-to-use moving process”. Because the three steps described above form one transaction, this method is called a “transaction move”.

To such a system in which contents of which the copyright should be protected are transmitted and received between the transmitting apparatus and the receiving apparatus via the network, a regulation is sometimes applied where “if the receiving apparatus has not used a decryption key for a predetermined period of time, the receiving apparatus should discard (i.e., invalidate) the decryption key”.

Let us discuss moving edited contents that include a plurality of partial contents to which mutually different types of copy control information are attached. For example, let us assume that the edited contents include a partial content 1 to which copy control information “No more copies” is attached, a partial content 2 to which copy control information “Copy free” is attached, and a partial content 3 to which copy control information “No more copies” is attached, the partial contents 1, 2, and 3 being joined together. In principle, to move the edited contents, the partial contents to each of which the copy control information “No more copies” is attached are transferred after being encrypted, whereas the partial content to which the copy control information “Copy free” is attached is transferred without being encrypted.

Thus, to move the edited contents, the transmitting apparatus and the receiving apparatus first perform an authentication and key exchange process between each other so that a shared key “a” to be used in the encryption and the decryption processes is shared between each other. After the moving of the edited contents has been started, when a predetermined period of time has elapsed since the receiving apparatus starts receiving the partial content 2 in the edited contents, which is being transferred without being encrypted, the receiving apparatus discards the shared key “a”. On the other hand, to transmit the partial content 3, which is transferred after being encrypted, immediately after the partial content 2 was transmitted, the transmitting apparatus transmits the partial content 3 to the receiving apparatus after encrypting the partial content 3 with the shared key “a”. However, even if the receiving apparatus has received the partial content 3, which is transferred after being encrypted, after the partial content 2 was transferred, the receiving apparatus is not able to decrypt the partial content 3 because the receiving apparatus discarded the shared key “a”.

In addition, when contents are moved, it is often difficult for the transmitting apparatus to check to see if each receiving apparatus is an authentic receiving apparatus that shares the shared key “a” with the transmitting apparatus. For this reason, it is difficult for the receiving apparatus to request an authentication and key exchange process again from the transmitting apparatus so as to obtain the shared key “a” and share it with the transmitting apparatus.

Let us discuss an example of a method for moving edited contents. In the case where edited contents are divided into sections so that the divided sections are moved from a transmitting apparatus to a receiving apparatus as individual contents, the receiving apparatus joins the divided individual contents together so as to restore the original undivided contents. When this method is used, a problem arises where it is difficult to join the contents together with smooth transitions therebetween. When “it is difficult to join the contents together with smooth transitions between them”, it means that it is difficult to play back the contents with smooth transitions therebetween because, for example, some frames are missing from the pictures played back. For example, as for MPEG 2 contents, in the case where the contents are divided at an “I picture” which is an ideal dividing position and joined together, it is possible to play back the contents with smooth transitions between them. However, in the case where the contents are divided at an arbitrarily-selected position other than the ideal dividing position, a number of pictures such as a “P picture” and a “B picture” that are positioned at the beginning of the second content resulting from the division are discarded. As a result, even if the divided contents are joined together, it is difficult to play back the contents with smooth transitions therebetween because of the number of pictures that have been discarded.

To solve the problem described above, JP-A 2006-338779 (KOKAI) discloses a technique where management information is created before contents are divided, so that the contents can be joined together with smooth transitions therebetween by using both the management information of the contents before being divided and the management information of the contents after being divided.

However, in the case where it is not possible to create such management information in advance in view of protection the copyrights or the like, it is not possible to apply the method disclosed in JP-A 2006-338779 (KOKAI) and it is therefore difficult to join the divided contents together smoothly. Consequently, in the situation where the shared key may be discarded to protect the copyright, it is difficult to move the contents from a transmitting apparatus to a receiving apparatus without fail, without missing any portion of the contents.

### SUMMARY OF THE INVENTION

According to one aspect of the present invention, a transmitting apparatus that transmits a content containing element data in units of groups to a receiving apparatus, the transmitting apparatus includes an encrypting unit that encrypts a first portion and a third portion, respectively, the content containing at least, in a stated order, the first portion that is encrypted with a shared key shared between the transmitting apparatus and the receiving apparatus, a second portion that is not encrypted, and the third portion that is encrypted with the shared key and a transmitting unit that sequentially transmits the encrypted first portion, the second portion, and the encrypted third portion, wherein the transmitting unit sequentially transmits sequentially transmits the encrypted first portion, the second portion, then a fourth portion and the encrypted third portion to the receiving apparatus, the fourth portion containing at least element data that belongs to a last group in the second portion, when the encrypted third portion has become a transmission target after transmitting the second portion and there is a possibility that the shared key stored in the receiving apparatus is invalidated when the encrypted third portion is received.

According to another aspect of the present invention, a receiving apparatus that receives a content containing element data in units of groups from a transmitting apparatus, the receiving apparatus includes a receiving unit that receives a fourth portion and a third portion that is encrypted sequentially from the transmitting apparatus, when there is a possibility that the shared key is invalidated after receiving a first portion that is encrypted and a second portion sequentially from the transmitting apparatus, the content containing at least, in a stated order, the first portion that is encrypted with a shared key shared between the receiving apparatus and the transmitting apparatus, the second portion that is not encrypted, the third portion that is encrypted with the shared key and the fourth portion containing element data that belongs to a last group in the second portion, a decrypting unit that decrypts the encrypted first portion and the encrypted third portion, respectively; and a joining unit that joins the second portion and the third portion together after deleting one of the fourth portion containing the element data that belongs to the last group in the received second portion and the fourth portion that has been received after the second portion was received.

According to still another aspect of the present invention, a content transmitting and receiving system in which a content containing element data in units of groups is transmitted from a transmitting apparatus to a receiving apparatus, the content transmitting and receiving system includes a counting unit that counts a progress amount indicating a progress of the transmission of a second portion or a progress of the reception of a second portion, the content containing at least, in a stated order, a first portion that is encrypted with a shared key shared between the receiving apparatus and the transmitting apparatus, the second portion that is not encrypted, and a third portion that is encrypted with the shared key, wherein the transmitting apparatus includes an encrypting unit that encrypts the first portion and the third portion, and a transmitting unit that sequentially transmits the encrypted first portion, the second portion, and the encrypted third portion, the transmitting unit sequentially transmits the first portion, the second portion, a fourth portion and the encrypted third portion to the receiving apparatus, the fourth portion containing element data that belongs to a last group in the second portion, when the encrypted third portion has become a transmission target after transmitting the second portion, and the counted progress amount has exceeded a threshold value, the receiving apparatus includes a receiving unit that receives the fourth portion and the encrypted third portion sequentially from the transmitting apparatus, the fourth portion containing the element data that belongs to the last group in the second portion, when the counted progress amount has exceeded the threshold value after the encrypted first portion and the second portion have sequentially been received from the transmitting apparatus, a decrypting unit that decrypts the encrypted first portion and the encrypted third portion, respectively, and a joining unit that joins the second portion and the third portion together after deleting one of the fourth portion containing the element data that belongs to the last group in the received second portion and the fourth portion that has been received after the second portion was received.

According to still another aspect of the present invention, a content transmitting method implemented in a transmitting apparatus that transmits a content containing element data in units of groups to a receiving apparatus, and the transmitting apparatus includes an encrypting unit and a transmitting unit, the method includes encrypting a first portion and a third portion, respectively by the encrypting unit, the content containing at least, in a stated order, the first portion that is encrypted with a shared key shared between the transmitting apparatus and the receiving apparatus, the second portion that is not encrypted, and the third portion that is encrypted with the shared key, and the transmitting apparatus includes an encrypting unit and a transmitting unit, transmitting sequentially the encrypted first portion, the second portion, and the encrypted third portion by the transmitting unit; and transmitting sequentially the encrypted first portion, the second portion, then a fourth portion and the encrypted third portion to the receiving apparatus, the fourth portion containing at least element data that belongs to a last group in the second portion, when the encrypted third portion has become a transmission target after transmitting the second portion, and there is a possibility that the shared key stored in the receiving apparatus is invalidated when the encrypted third portion is received.

According to still another aspect of the present invention, a content receiving method implemented in a receiving apparatus that receives a content containing element data in units of groups from a transmitting apparatus, and the receiving apparatus includes a receiving unit, a decrypting unit, and a joining unit, the method includes receiving a fourth portion and a third portion that is encrypted sequentially from the transmitting apparatus, when there is a possibility that the shared key is invalidated after receiving a first portion that is encrypted and a second portion sequentially from the transmitting apparatus, the content containing at least, in a stated order, the first portion that is encrypted with a shared key shared between the receiving apparatus and the transmitting apparatus, the second portion that is not encrypted, the third portion that is encrypted with the shared key and the fourth portion containing element data that belongs to a last group in the second portion decrypting the encrypted first portion and the encrypted third portion, respectively by the decrypting unit; and joining the second portion and the third portion together by the joining unit after deleting one of the fourth portion containing the element data that belongs to the last group in the received second portion and the fourth portion that has been received after the second portion was received.

Computer program products according to still another aspect of the present invention cause a computer to perform the methods according to the present invention.

### BRIEF DESCRIPTION OF THE DRAWINGS

FIG. 1 is a diagram illustrating an example of a content transmitting and receiving system according to an embodiment of the present invention;

FIG. 2 is a diagram illustrating an example of a structure of contents that are treated as a target of a moving process according to the embodiment;

FIG. 3 is an exemplary functional diagram illustrating a transmitting apparatus according to the embodiment;

FIG. 4 is an exemplary functional diagram illustrating a receiving apparatus according to the embodiment;

FIG. 5 is a flowchart of an overall procedure in a content moving process performed in the content transmitting and receiving system according to the embodiment;

FIG. 6 is a diagram illustrating an example of content management information according to the embodiment;

FIG. 7 is a diagram illustrating an example of information used in a right-to-use moving process according to the embodiment;

FIG. 8 is a flowchart of the right-to-use moving process according to the embodiment;

FIG. 9 is a diagram illustrating an example of contents F that contains a partial content C1 and a partial content C2 according to the embodiment;

FIG. 10 is a diagram illustrating another example of the content management information according to the embodiment;

FIG. 11 is a diagram illustrating an example of contents G that contains a duplicate of a portion of the partial content C2 and a partial content C3 according to the embodiment;

FIG. 12 is a diagram illustrating another example of the information used in another right-to-use moving process according to the embodiment;

FIG. 13 is a flowchart of a detailed procedure in a process performed by the transmitting apparatus according to the embodiment;

FIG. 14 is a flowchart of a detailed procedure in a process performed by the receiving apparatus according to the embodiment; and

FIG. 15 is a flowchart of a procedure in a process performed by the receiving apparatus according to a modification example of the embodiment.

### DETAILED DESCRIPTION OF THE INVENTION

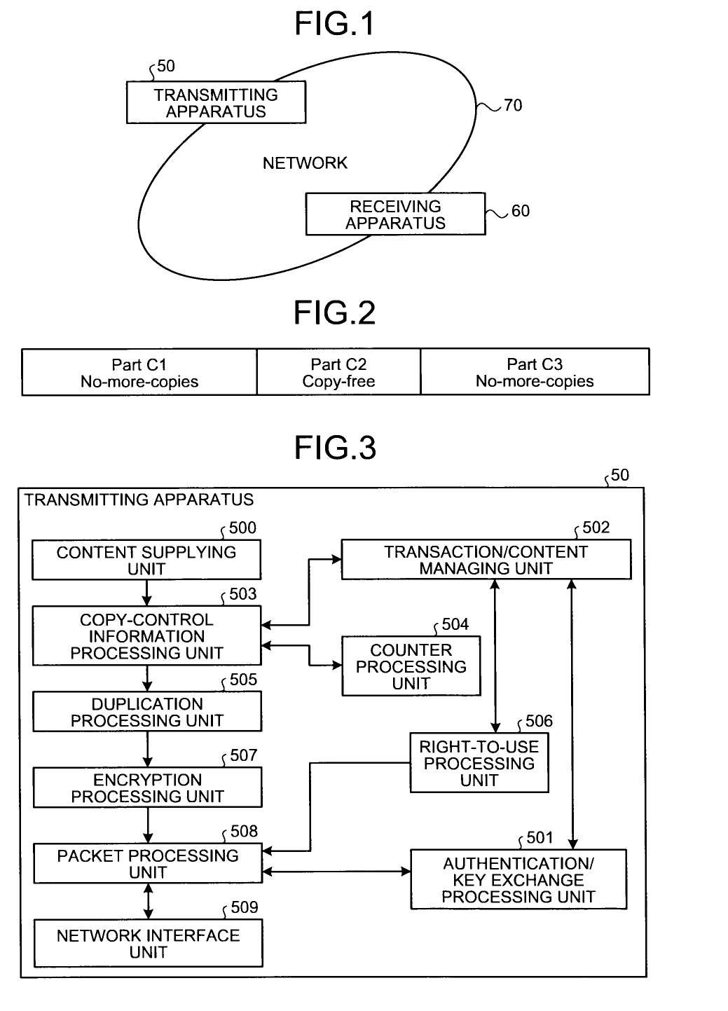

FIG. 1 is a diagram illustrating an example of a content transmitting and receiving system according to an embodiment of the present invention. In the content transmitting and receiving system, a transmitting apparatus 50 and a receiving apparatus 60 are connected to each other via a network 70. The network 70 may be, for example, an Ethernet (registered trademark), a wired network based on the Institute of Electrical and Electronics Engineers (IEEE) 1394 or a Universal Serial Bus (USB), or a wireless network based on the IEEE 802.11 or a Bluetooth. The transmitting apparatus 50 transmits contents that serve as the target of a moving process (hereinafter “moving target contents”) to the receiving apparatus 60 via the network 70. The receiving apparatus 60 receives the contents that have been transmitted from the transmitting apparatus 50 via the network 70.

The moving target contents according to the present embodiment contain, at least, “digital data of which the copyright should be protected”, “digital data of which the copyright does not have to be protected”, and “digital data of which the copyright should be protected” in the stated order. The contents are a result of an editing process performed by a user to join together a portion taken out of the “digital data of which the copyright should be protected”, a portion taken out of the “digital data of which the copyright does not have to be protected”, and a portion taken out of the “digital data of which the copyright should be protected”.

The “digital data of which the copyright should be protected” denotes a “digital content that should be transferred after a restriction related to copyright protection is applied thereto”. As for the “digital data of which the copyright should be protected”, it is assumed that copying of the digital data is prohibited, but the moving of the digital data is permitted. It is also assumed that the “digital data of which the copyright should be protected” is transferred from the transmitting apparatus 50 to the receiving apparatus 60 after being encrypted with a shared key that is shared between the transmitting apparatus 50 and the receiving apparatus 60, as explained later. On the other hand, the “digital data of which the copyright does not have to be protected” denotes a “digital content that is transferred without applying any restriction related to copyright protection thereto”. As for the “digital data of which the copyright does not have to be protected”, it is assumed that copying and moving of the digital data is permitted. It is also assumed that the “digital data of which the copyright does not have to be protected” is transferred from the transmitting apparatus 50 to the receiving apparatus 60 without being encrypted.

Each of the different types of digital data contains pieces of element data that constitute the digital data in units of groups. For example, in the MPEG 2 format, each of the pieces of element data is an image that is one of an I picture, a P picture, and a B picture. A plurality of pictures starting with an I picture belong to each Group of Pictures (GOP). The GOPs are configured so as to be independent of one another. In the MPEG 2 format, each piece of digital data is configured so as to contain at least one GOP.

FIG. 2 is a diagram illustrating an example of a structure of contents that are treated as the target of the moving process according to the present embodiment. Moving target contents C contains, in the stated order, a partial content C1 to which copy control information “No more copies”, as explained above, is attached, another partial content C2 to which copy control information “Copy free” is attached, and yet another partial content C3 to which copy control information “No more copies” is attached. According to the present embodiment, in view of copyright protection, the partial contents C1 and C3 are moved from the transmitting apparatus 50 to the receiving apparatus 60 after being encrypted, whereas the partial content C2 is moved without being encrypted.

When the moving target contents C configured as described above are to be moved from the transmitting apparatus 50 to the receiving apparatus 60, according to the present embodiment, the partial content C1 is transmitted first, and subsequently, after the transmission of the partial content C2, which is transferred without being encrypted, is started (in other words, after the shared key used in the encryption process stops being used), a progress amount indicating the progress of the transmission is counted. After that, when the transmitting apparatus 50 transmits the partial content C3, which is to be transferred after being encrypted, in the case where there is a possibility that the shared key stored in the receiving apparatus 60 may be invalidated (in other words, in the case where the progress amount has exceeded a threshold value), a new transaction is established between the transmitting apparatus 50 and the receiving apparatus 60 so that the transmitting apparatus 50 sequentially transmits, to the receiving apparatus 60, a duplicate of a portion of the partial content C2 and the encrypted partial content C3, in the new transaction. On the other hand, the receiving apparatus 60 deletes one of the duplicate portions and joins together the partial contents C2 and C3 that have been received from the transmitting apparatus 50. It should be noted that the partial content C2 is already joined to the partial content C1 because the partial content C2 is transmitted immediately following the partial content C1. As a result of the processes described above, the moving target contents have been moved from the transmitting apparatus 50 to the receiving apparatus 60.

Next, hardware configurations of the transmitting apparatus 50 and the receiving apparatus 60 will be explained. The transmitting apparatus 50 and the receiving apparatus 60 are each configured so as to include a controlling device such as a Central Processing Unit (CPU) that exercises the overall control of the apparatus; storage devices such as a Read-Only Memory (ROM) and Random Access Memory (RAM) that store therein various types of data and various types of computer programs (hereinafter, “programs”); external storage devices such as a Hard Disk Drive (HDD) and a Compact Disk (CD) drive device that store therein various types of data and various types of programs; a communication controlling device that performs communication via the network 70 with computers provided on the outside of the apparatus; and a bus that connects these constituent elements to one another. The transmitting apparatus 50 and the receiving apparatus 60 each have a hardware configuration to which a commonly-used computer can be applied. In addition, a display device such as a display monitor that displays information and input devices such as a keyboard and a mouse that are used by the user to input various types of processing requests to the apparatus are connected to the transmitting apparatus 50 and to the receiving apparatus 60 in a wired or wireless manner.

Next, various types of functions that are realized in the hardware configuration described above when the transmitting apparatus 50 executes the various types of programs stored in the storage devices and the external storage devices will be explained, with reference to FIG. 3. The transmitting apparatus 50 includes a content supplying unit 500, an authentication/key exchange processing unit 501, a transaction/content managing unit 502, a copy control information processing unit 503, a counter processing unit 504, a duplication processing unit 505, a right-to-use processing unit 506, an encryption processing unit 507, a packet processing unit 508, and a network interface unit 509. The actual substance of each of these constituent elements is generated in, for example, a storage device (e.g., the RAM) when the CPU of the transmitting apparatus 50 executes the various types of programs.

The content supplying unit 500 supplies the moving target contents to the copy control information processing unit 503. The moving target contents are stored in, for example, an external storage device or a storage device, while being in a usable state (i.e., a valid state). For example, to store the contents while the contents are in a valid state means to provide a flag in correspondence with the contents so that the flag is set so as to indicate a valid state. The flag may be stored in the external storage device or the storage device together with the contents. Alternatively, the flag may be stored separately from the contents. The content supplying unit 500 reads the moving target contents from the external storage device or the storage device and supplies the read contents to the copy control information processing unit 503.

The authentication/key exchange processing unit 501 performs an authentication and key exchange process between the transmitting apparatus and the receiving apparatus 60. In this situation, the authentication and key exchange process is a process in which the transmitting apparatus 50 and the receiving apparatus 60 authenticate each other to confirm that these apparatuses are properly licensed by a specific licensing organization and, in the case where these apparatuses have been confirmed to be authentic apparatuses, a key used in common between these apparatuses (i.e., a shared key) is generated. In other words, when the authentication and key exchange process has successfully been performed, the transmitting apparatus 50 and the receiving apparatus 60 are able to own the shared key to be used in common for encrypting or decrypting the contents. To perform the authentication process, it is acceptable to use any of the publicly-known methods such as the one defined by the International Organization for Standardization (ISO)/the International Electrotechnical Commission (IEC) 9798-3 or ISO/IEC 9798-2.

When moving the moving target contents, the copy control information processing unit 503 identifies the copy control information attached to each of the partial contents contained in the moving target contents and controls encryption and transmission of each of the partial contents according to the attached copy control information. More specifically, when the moving target contents are to be moved, in the case where the copy control information processing unit 503 has detected “digital data of which the copyright does not have to be protected” (e.g., a content to which the copy control information “Copy free” is attached, like the partial content C2 in the present example), the copy control information processing unit 503 requests the counter processing unit 504 to start a counting process. After that, in the case where the copy control information processing unit 503 has detected “digital data of which the copyright should be protected” (e.g., a content to which the copy control information “No more copies” is attached, like the partial content C3 in the present example), and also, the copy control information processing unit 503 has been notified by the counter processing unit 504 that the progress amount indicating the progress of the transmission has exceeded the threshold value, the copy control information processing unit 503 requests the transaction/content managing unit 502 to establish a new transaction. Subsequently, the copy control information processing unit 503 requests the duplication processing unit 505 to make duplicates of a portion of the “digital data of which the copyright does not have to be protected” (i.e., the partial content C2 in the present example) that is positioned before the partial content C3. In this situation, by using a duplication flag, the copy control information processing unit 503 separately makes the request for establishing the new transaction and the request for making the duplicate of the portion of the partial content C2. The duplication flag is stored in, for example, a storage device like the RAM. The specific usage of the duplication flag will be explained later in the description of the operation. After that, the copy control information processing unit 503 requests the encryption processing unit 507 to encrypt the duplicated portion of the partial content C2 and the partial content C3.

The transaction/content managing unit 502 stores therein correspondence relationships between the moving target contents and transactions and also controls reading and deletion of the stored correspondence relationships. In addition, when having been requested by the copy control information processing unit 503 to establish a new transaction, the transaction/content managing unit 502 establishes a new transaction between the transmitting apparatus 50 and the receiving apparatus 60.

When having been requested by the copy control information processing unit 503 to start a counting process, the counter processing unit 504 counts a progress amount indicating the progress of a transmission. When the progress amount has exceeded the threshold value, the counter processing unit 504 notifies the copy control information processing unit 503. The progress amount indicating the progress of the transmission is expressed by, for example, how much time has been spent in performing the transmission process. The threshold value is specified as a value that is equal to or shorter than a predetermined period of time (e.g., two hours) between the time at which the receiving apparatus 60 stops using the shared key and the time at which the receiving apparatus 60 invalidates the shared key. The threshold value is stored in advance in a storage device or an external storage device.

In the case where it turns out that the “digital data of which the copyright should be protected” (i.e., the partial content C3 in the present example) needs to be moved before the progress amount has exceeds the threshold value, (in other words, the use of the shared key needs to be resumed), the counter processing unit 504 resets the count of the progress amount.

When having been requested by the copy control information processing unit 503 to make a duplicate of a portion of the “digital data of which the copyright does not have to be protected” (i.e., the partial content C2 in the present example), the duplication processing unit 505 makes the duplicate of a portion of the partial content C2.

The right-to-use processing unit 506 performs a process (hereinafter, the “right-to-use moving process”) to move the right to use for the contents from the transmitting apparatus 50 to the receiving apparatus 60. In addition, the right-to-use processing unit 506 generates information used in the right-to-use moving process and controls reading and deletion of the generated information.

In response to a request from the copy control information processing unit 503, the encryption processing unit 507 encrypts the partial contents by using the shared key that the transmission apparatus 50 and the receiving apparatus 60 share as a result of the authentication and key exchange process performed by the authentication/key exchange processing unit 501 and supplies the encrypted partial contents to the packet processing unit 508.

The packet processing unit 508 performs processes in a network layer and a transport layer in the communication process between the transmitting apparatus 50 and the receiving apparatus 60. More specifically, the packet processing unit 508 performs, for example, a process to convert the contents to be transmitted to the receiving apparatus 60 and commands used in the right-to-use moving process into packets. The network interface unit 509 performs processes in a physical layer and a data link layer in the communication process between the transmitting apparatus 50 and the receiving apparatus 60.

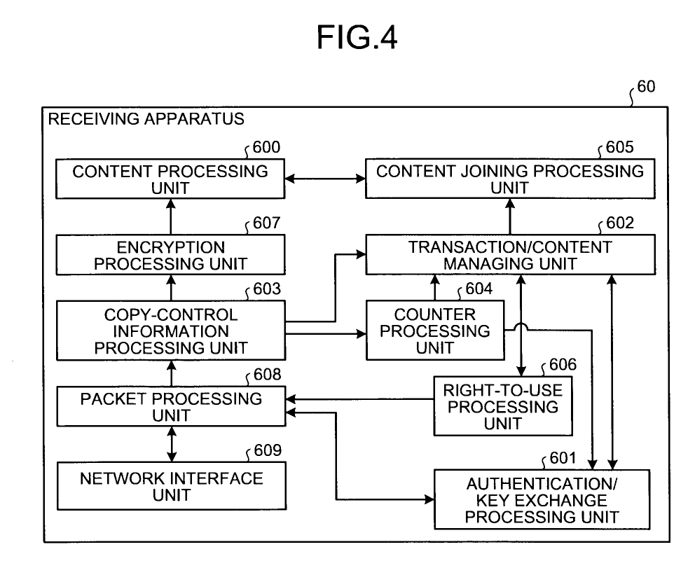

Next, various types of functions that are realized in the hardware configuration described above when the receiving apparatus 60 executes the various types of programs stored in the storage devices and the external storage devices will be explained, with reference to FIG. 4. The receiving apparatus 60 includes a content processing unit 600, an authentication/key exchange processing unit 601, a transaction/content managing unit 602, a copy control information processing unit 603, a counter processing unit 604, a right-to-use processing unit 606, an encryption processing unit 607, a packet processing unit 608, a network interface unit 609, and a content joining processing unit 605. The actual substance of each of these constituent elements is generated in, for example, a storage device (e.g., the RAM) when the CPU of the receiving apparatus 60 executes the various types of programs.

The right-to-use processing unit 606, the packet processing unit 608, and the network interface unit 609 have the same functions as the right-to-use processing unit 506, the packet processing unit 508, and the network interface unit 509 that are included in the transmitting apparatus 50, respectively. Thus, the explanation thereof will be omitted.

The content processing unit 600 performs a process to output the moving target contents that have been received from the transmitting apparatus 50 to the display device or to store the received moving target contents. The content processing unit 600 stores the received moving target contents into an external storage device or a storage device while the moving target contents are in a usable state (i.e., a valid state) or in an unusable state (i.e., an invalid state) according to the right-to-use moving process described later. For example, a flag may be provided in correspondence with the contents, so that the flag is set so as to indicate a valid state or in an invalid state. The flag may be stored in the external storage device or the storage device together with the contents. Alternatively, the flag may be stored separately from the contents. When one of the partial contents contained in the moving target contents has been received, the copy control information processing unit 603 identifies the copy control information attached to the partial contents and judges whether it is necessary to perform a decryption process thereon. According to the result of the judging process, the copy control information processing unit 603 requests the encryption processing unit 607 to perform a decryption process on the partial content. In response to the request from the copy control information processing unit 603, the encryption processing unit 607 decrypts the partial content with the shared key and supplies the decrypted partial content to the content processing unit 600.

The authentication/key exchange processing unit 601 performs the authentication and key exchange process between the receiving apparatus 60 and the transmitting apparatus 50 and stores the shared key that is shared with the transmitting apparatus 50 into a storage device such as the RAM. When having been notified by the counter processing unit 604 that the period of time that has elapsed since the shared key stops being used has exceeded the predetermined length of time, the authentication/key exchange processing unit 601 invalidates the shared key by deleting the shared key from the storage device. Another arrangement is acceptable in which, instead of deleting the shared key, a state indicating flag indicating whether the shared key is usable (i.e., is in a valid state) or is unusable (i.e., is in an invalid state) is stored in the storage device in correspondence with the shared key, so that in the case where the authentication/key exchange processing unit 601 has been notified by the counter processing unit 604 that the period of time that has elapsed since the shared key stops being used has exceeded the predetermined length of time, the authentication/key exchange processing unit 601 changes the state indicating flag so as to indicate that the shared key is in an invalid state.

The counter processing unit 604 measures the period of time that has elapsed since the shared key stops being used due to the authentication and key exchange process performed by the authentication/key exchange processing unit 601. When the elapsed period of time has exceeded the predetermined length of time, the counter processing unit 604 notifies the authentication/key exchange processing unit 601.

When having been requested by the transmitting apparatus 50 to establish a new transaction, the transaction/content managing unit 602 establishes a new transaction between the receiving apparatus 60 and the transmitting apparatus 50. The content joining processing unit 605 obtains the correspondence relationship between the contents and the transactions from the transaction/content managing unit 602, and in the case where there are two or more mutually different transaction for one set of contents, the content joining processing unit 605 performs a joining process to delete one of the duplicate portions and join the contents together.

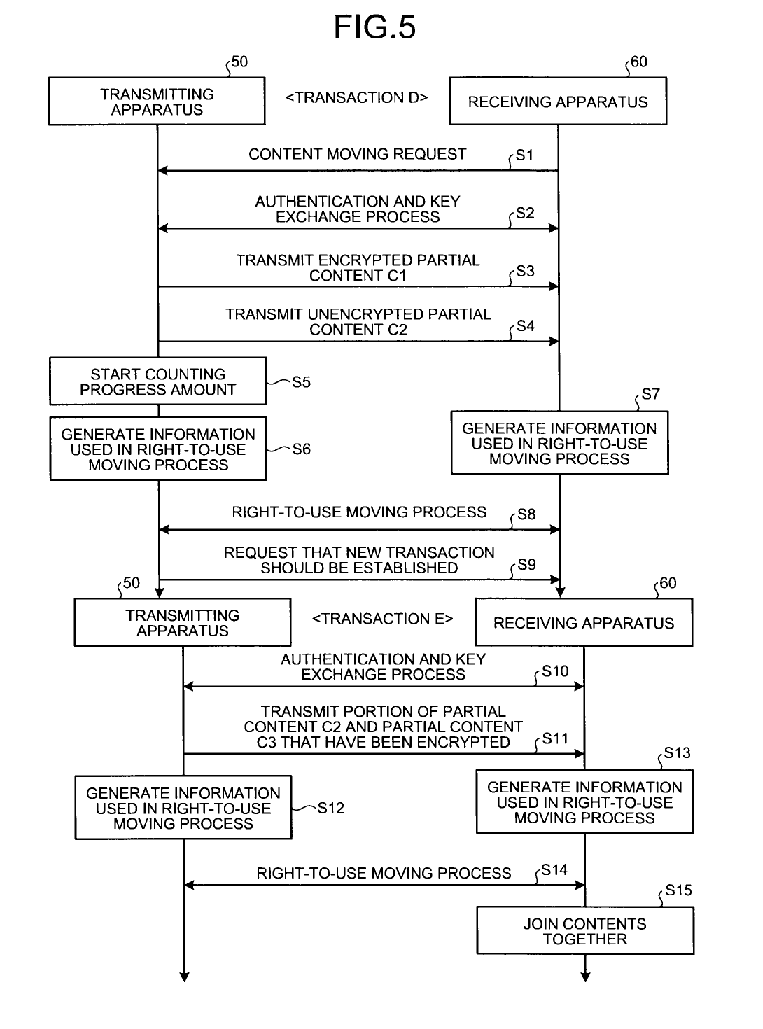

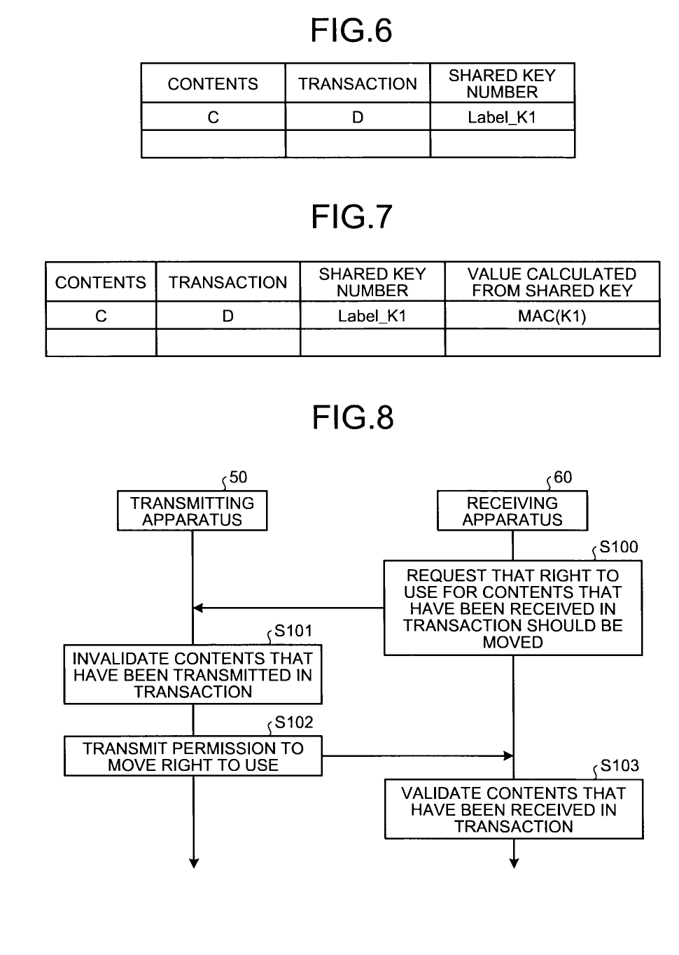

Next, an overall procedure in the content moving process performed in the content transmitting and receiving system according to the present embodiment will be explained, with reference to FIG. 5. First, the receiving apparatus 60 transmits a content moving request to the transmitting apparatus 50 to request that moving target contents should be moved (Step S1). Subsequently, the transmitting apparatus 50 and the receiving apparatus 60 performs the authentication and key exchange process with each other and shares a shared key so that a transaction is started (Step S2). In the following explanation, the moving target contents will be identified with an identifier “C”, whereas the transaction that has been started will be identified with an identifier “D”. The shared key will be identified with an identifier “K1”, while the number of the shared key is “Label_K1”. In this situation, as shown in FIG. 6, the transaction/content managing unit 502 included in the transmitting apparatus 50 and the transaction/content managing unit 602 included in the receiving apparatus 60 each store the identifier “C” identifying the moving target contents, the identifier “D” identifying the transaction, and the identifier “Label_K1” identifying the shared key into a storage device or the like, as content management information, while keeping the identifiers in correspondence with one another. It is preferable to have an arrangement in which the transmitting apparatus 50 locks the contents so that, even if another receiving apparatus transmits a content moving request to the transmitting apparatus 50 to request that the same moving target contents C should be moved, the transmitting apparatus 50 is able to reject the request.

When the authentication and key exchange process related to the transaction D has successfully been performed, the content supplying unit 500 included in the transmitting apparatus 50 reads the moving target contents C from the external storage device or the storage device and supplies the read moving target contents C to the copy control information processing unit 503. When the copy control information processing unit 503 identifies the copy control information “No more copies” attached to the first partial content C1 contained in the moving target contents C that have been supplied from the content supplying unit 500 and detects that the partial content C1 is “digital data of which the copyright should be protected”, i.e., a “portion that should be transferred after being encrypted”, the copy control information processing unit 503 requests the encryption processing unit 507 to encrypt the partial content C1 with the shared key K1. The encryption processing unit 507 encrypts the partial content C1 with the shared key K1 and supplies the encrypted partial content C1 to the packet processing unit 508. The packet processing unit 508 converts the encrypted partial content C1 into a predetermined packet and supplies the packet to the network interface unit 509. The network interface unit 509 transmits the packet that has been supplied from the packet processing unit 508 to the receiving apparatus 60 (Step S3).

On the other hand, when the receiving apparatus 60 has received the packet via the network interface unit 609, the packet processing unit 608 takes the encrypted partial content C1 out of the packet. The copy control information processing unit 603 judges whether it is necessary to perform a decryption process based on the copy control information and supplies the encrypted partial content C1 to the encryption processing unit 607. The encryption processing unit 607 decrypts the encrypted partial content C1 with the shared key K1 and supplies the decrypted partial content C1 to the content processing unit 600. The content processing unit 600 stores the partial content C1 that has been supplied from the encryption processing unit 607 into an external storage device or a storage device. In this situation, the content processing unit 600 stores the partial content C1 into the external storage device or the storage device while the partial content C1 is in an invalid state (i.e., an unusable state).

After that, when the transmission of the partial content C1 contained in the moving target contents C has been completed and the transmission of the partial content C2 is to be started, the copy control information processing unit 503 included in the transmitting apparatus 50 identifies the copy control information “Copy free” attached to the partial content C2 and detects that the partial content C2 is “digital data of which the copyright does not have to be protected”, i.e., a “portion that is transferred without being encrypted”. As a result, the copy control information processing unit 503 supplies the partial content C2 to the packet processing unit 508. The packet processing unit 508 converts the partial content C2 into a predetermined packet and supplies the packet to the network interface unit 509. The network interface unit 509 transmits the packet that has been supplied from the packet processing unit 508 to the receiving apparatus 60 (Step S4). As a result, the partial content C2 has been transmitted to the receiving apparatus 60 without being encrypted. In addition, when the copy control information processing unit 503 has detected that the copy control information “Copy free” is attached to the partial content C2, the copy control information processing unit 503 requests the counter processing unit 504 to start the counting process for the transaction D because the shared key 1 stops being used (Step S5).

On the other hand, when the receiving apparatus 60 has received the packet corresponding to the partial content C2 via the network interface unit 609, the packet processing unit 608 takes the partial content C2 out of the packet. The copy control information processing unit 603 judges whether it is necessary to perform a decryption process based on the copy control information and supplies the partial content C2 to the content processing unit 600, instead of to the encryption processing unit 607, because the partial content C2 is not encrypted and does not have to be decrypted. When having received the partial content C2 that has been supplied, the content processing unit 600 stores the partial content C2 into an external storage device or a storage device while the partial content C2 in an invalid state (i.e., an unusable state).

When having been requested by the copy control information processing unit 503 to start a counting process, the counter processing unit 504 included in the transmitting apparatus 50 counts the progress amount indicating the progress of the transmission and, when the progress amount has exceeded the threshold value, the counter processing unit 504 notifies the copy control information processing unit 503. After the process at Step S5 is performed, in the case where the copy control information processing unit 503 included in the transmitting apparatus 50 has detected a content to which the copy control information “No more copies” is attached (i.e., the partial content C3 in the present example), and also, the copy control information processing unit 503 has been notified by the counter processing unit 504 that the progress amount indicating the progress of the transmission has exceeded the threshold value, the copy control information processing unit 503 has a new transaction established so that the remaining partial content can be transmitted.

The right-to-use processing unit 506 included in the transmitting apparatus 50 generates information used in the right-to-use moving process performed on all or a part of the moving target contents C that have been transmitted in the transaction D and stores the generated information into an external storage device or a storage device (Step S6). Similarly, the right-to-use processing unit 606 included in the receiving apparatus 60 generates information used in the right-to-use moving process performed on all or a part of the moving target contents C that have been transmitted in the transaction D and stores the generated information into an external storage device or a storage device (Step S7). FIG. 7 is a diagram illustrating an example of the information used in the right-to-use moving process. In the example shown in FIG. 7, the information includes the identifier “C” identifying the moving target contents C, the identifier “D” identifying the transaction used for moving the moving target contents C, the number “Label_K1” identifying the shared key used in the transaction, and the information “MAC(K1)” calculated from the shared key.

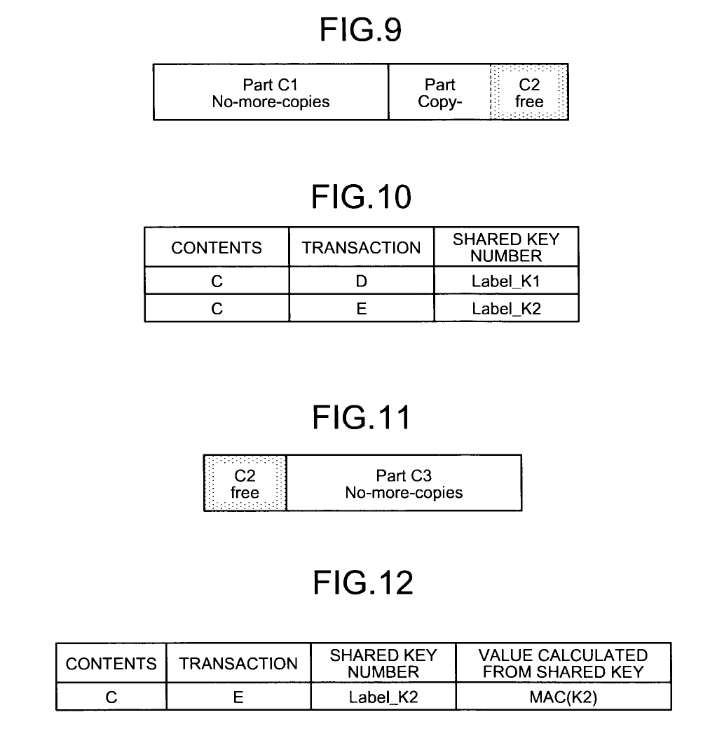

After that, the transmitting apparatus 50 and the receiving apparatus 60 perform the right-to-use moving process on all or a part of the moving target contents C that have been transmitted and received in the transaction D (Step S8). FIG. 8 is a flowchart of the right-to-use moving process. In this situation, the receiving apparatus 60 transmits a right-to-use moving request to the transmitting apparatus 50 to request that the right to use for contents F should be moved, the contents F containing, as shown in FIG. 9, the partial content C1 and the partial content C2 that have been received in the transaction D (Step S100). When having received the right-to-use moving request, the transmitting apparatus 50 causes the partial content C1 and the partial content C2 contained in the moving target contents C stored in the external storage device in the transmitting apparatus 50 to be in an invalid state, in response to the request (Step S101) and transmits a right-to-use moving permission to the receiving apparatus 60 (Step S102). When having received the right-to-use moving permission, the receiving apparatus 60 changes the use state of the contents F stored in the external storage device in the receiving apparatus 60 to a valid state (Step S103). As a result, the right to use for the contents F has been moved from the transmitting apparatus 50 to the receiving apparatus 60, and the right-to-use moving process is thus completed.

In the case where the authentication/key exchange processing unit 601 included in the receiving apparatus 60 has been notified by the counter processing unit 604 that the period of time that has elapsed since the shared key K1 stops being used has exceeded the predetermined length of time, the authentication/key exchange processing unit 601 deletes the shared key K1 from the storage device. As a result, the receiving apparatus 60 becomes unable to decrypt any content that is encrypted with the shared key K1. On the contrary, in the case where the period of time that has elapsed since the shared key K1 stops being used has not exceeded the predetermined length of time, the receiving apparatus 60 remains able to decrypt the contents that are encrypted with the shared key K1.

On the other hand, after the process at Step S5 is performed, in the case where the copy control information processing unit 503 included in the transmitting apparatus 50 has detected a content to which the copy control information “No more copies” is attached (i.e., the partial content C3 in the present example), but has not been notified by the counter processing unit 504 that the progress amount indicating the progress of the transmission has exceeded the threshold value, the copy control information processing unit 503 does not request that a new transaction should be established, because there is no possibility that the shared key K1 is invalidated. In this situation, the transmitting apparatus 50 encrypts the partial content C3 with the shared key 1 and transmits the encrypted partial content C3 to the receiving apparatus 60 in the ongoing transaction D.

Next, the procedure in a process performed in the case where, after the process at Step S5 is performed, the copy control information processing unit 503 included in the transmitting apparatus 50 has detected “digital data of which the copyright should be protected”, i.e., a content to which the copy control information “No more copies” is attached (the partial content C3 in the present example), and also, the copy control information processing unit 503 has been notified by the counter processing unit 504 that the progress amount indicating the progress of the transmission has exceeded threshold value will be explained. In this situation, the copy control information processing unit 503 requests the transaction/content managing unit 502 to establish a new transaction.

When having been requested by the copy control information processing unit 503 to establish a new transaction, the transaction/content managing unit 502 transmits an establishing request to the receiving apparatus 60 to request that a new transaction should be established (Step S9). Subsequently, the authentication/key exchange processing unit 501 performs the authentication and key exchange process with the authentication/key exchange processing unit 601 included in the receiving apparatus 60, so that a new shared key is shared between the apparatuses and a new transaction is started (Step S10). In the following explanation, the new transaction will be identified with an identifier “E”. The new shared key will be identified with an identifier “K2, while the number of the new shared key is “Label_K2”. In this situation, as shown in FIG. 10, the transaction/content managing unit 502 included in the transmitting apparatus 50 and the transaction/content managing unit 602 included in the receiving apparatus 60 each store the identifier “C” identifying the moving target contents, the identifier “E” identifying the new transaction, and the identifier “Label_K2” identifying the new shared key into a storage device, as content management information, while keeping the identifiers in correspondence with one another.

When the authentication and key exchange process for the transaction E has successfully been performed, the copy control information processing unit 503 included in the transmitting apparatus 50 requests the duplication processing unit 505 to duplicate a portion of the partial content C2. The “portion of the partial content C2” denotes a portion of the partial content C2, the portion being a certain amount starting from the end of the partial content C2. The “portion being a certain amount starting from the end” denotes a portion containing at least the element data that belongs to the last group in the partial content C2. For example, in the case where the partial content C2 is digital data in the MPEG 2 format, the duplicated portion corresponds to the portion up to the I picture that belongs to the last GOP in the partial content C2, i.e., the portion of the partial content C2 from the end thereof through the first I picture from the end of the partial content C2.

As shown in FIG. 11, in response to the request from the copy control information processing unit 503, the duplication processing unit 505 makes a duplicate of the portion of the partial content C2 and supplies the duplicated portion to the packet processing unit 508. The copy control information processing unit 503 then requests the encryption processing unit 507 to encrypt the partial content C3. In response to the request, the encryption processing unit 507 encrypts the partial content C3 with the shared key K2 and supplies the encrypted partial content C3 to the packet processing unit 508. The packet processing unit 508 converts contents G containing the duplicated portion of the partial content C2 and encrypted partial content C3 into a predetermined packet and supplies the packet to the network interface unit 509. The network interface unit 509 transmits the packet to the receiving apparatus 60 (Step S11).

When the receiving apparatus 60 has received the packet via the network interface unit 609, the packet processing unit 608 takes the contents G out of the packet. The copy control information processing unit 603 then judges whether it is necessary to perform a decryption process based on the copy control information and supplies the encrypted part of the contents G (i.e., the partial content C3 in the present example) to the encryption processing unit 607. The encryption processing unit 607 decrypts the encrypted part of the contents G (i.e., the partial content C3) with the new shared key K2 and supplies the portion of the partial content C2 and the decrypted partial content C3 to the content processing unit 600. The content processing unit 600 stores the portion of the partial content C2 and the partial content C3 that have been supplied from the encryption processing unit 607 into an external storage device or a storage device. In this situation, the content processing unit 600 stores the portion of the partial content C2 and the partial content C3 into the external storage device or the storage device while they are in an invalid state.

On the other hand, the right-to-use processing unit 506 included in the transmitting apparatus 50 generates information used in the right-to-use moving process performed on all or a part of the moving target contents C in the new transaction E and stores the generated information into an external storage device or a storage device (Step S12). Similarly, the right-to-use processing unit 606 included in the receiving apparatus 60 generates information used in the right-to-use moving process performed on all or a part of the moving target contents C in the new transaction E and stores the generated information into an external storage device or a storage device (Step S13). FIG. 12 is a diagram illustrating an example of the information used in the right-to-use moving process performed in this situation. In the example shown in FIG. 12, the information contains the identifier “C” identifying the moving target contents, the identifier “E” identifying the new transaction used for moving the moving target contents, the number “Label_K2” identifying the shared key used in the transaction, and information “MAC (K2)” calculated from the shared key.

After that, when the transmitting and receiving process of the entirety of the moving target contents C has been completed, the transmitting apparatus 50 and the receiving apparatus 60 perform the right-to-use moving process on all or a part of the moving target contents in the new transaction E (Step S14). In this situation, the receiving apparatus 60 transmits a right-to-use moving request to the transmitting apparatus 50 to request that the right to use for the contents G should be moved, the contents G containing, as shown in FIG. 11, the duplicated portion of the partial content C2 and the partial content C3 that have been received in the new transaction E. When having received the right-to-use moving request, the transmitting apparatus 50 causes the portion of the partial content C2 and the partial content C3 that constitute the contents G to be in an invalid state in response to the request, the portion of the partial content C2 and the partial content C3 constituting the contents G contained in the moving target contents C and being stored in the external storage device in the transmitting apparatus 50. The transmitting apparatus 50 then transmits a right-to-use moving permission to the receiving apparatus 60. When having received the right-to-use moving permission, the receiving apparatus 60 changes the use state of the portion of the partial content C2 and the partial content C3 that constitute the contents G and are stored in the external storage device in the receiving apparatus 60 to a valid state. As a result, the right to use for the contents G has been moved from the transmitting apparatus 50 to the receiving apparatus 60, and the right-to-use moving process has thus been completed.

After the transmitting and receiving process of the entirety of the moving target contents C has been completed, the receiving apparatus 60 refers to the content management information as shown in FIG. 10 and judges whether it is necessary to join any partial contents together. In the present example, because there have been mutually different transactions for the moving target contents C, the receiving apparatus 60 judges that it is necessary to join the partial contents together. If, however, there had been no mutually different transactions for the moving target contents C, it would not be necessary to join the partial contents together because the moving target contents C would have consecutively been received in mutually the same transaction. In the present example, with regard to the moving target contents C, the receiving apparatus 60 have received the two sets of contents in the transactions, the two sets namely being the contents F containing the partial content C1 and the partial content C2 as shown in FIG. 9 and the contents G containing the portion of the partial content C2 and the partial content C3 as shown in FIG. 11. The content processing unit 600 performs a content joining process to join the contents F and the contents G together (Step S15). To perform the content joining process, the content processing unit 600 joins the contents F and the Contents G together after deleting the duplicated portion. The content processing unit 600 may delete either one of the duplicated portions before joining the contents together. As a result, the receiving apparatus 60 is able to restore the moving target contents C in a complete manner. Thus, the moving target contents C have been moved from the transmitting apparatus 50 to the receiving apparatus 60 in a complete manner.

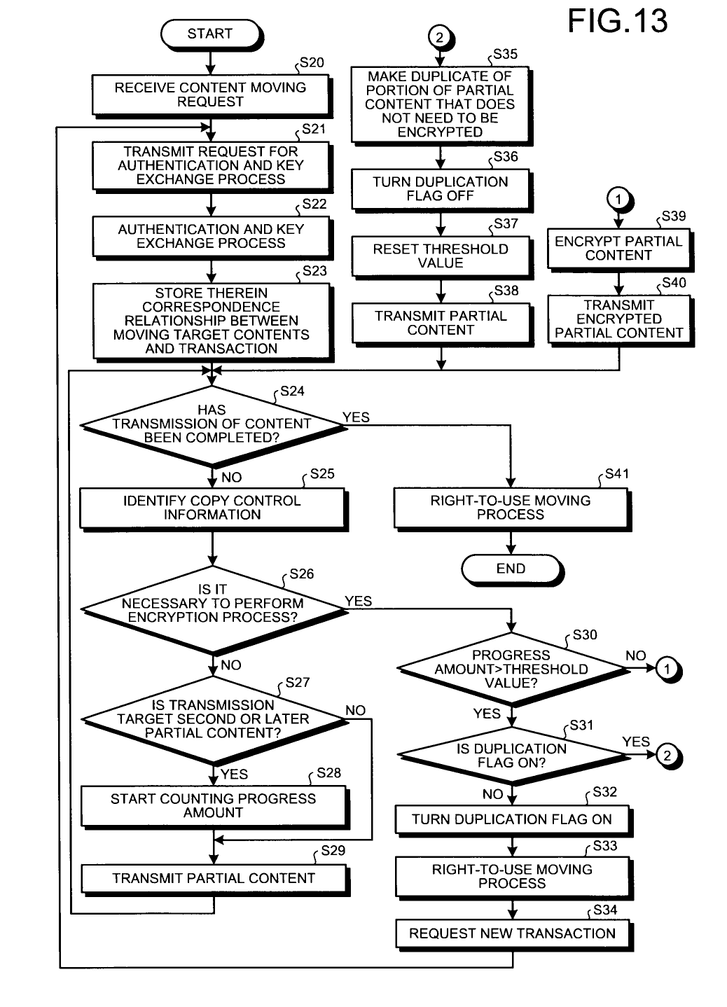

Next, a detailed procedure in the process performed by the transmitting apparatus 50 according to the present embodiment during the content moving process described above will be explained, with reference to FIG. 13. First, when the transmitting apparatus 50 has received, from the receiving apparatus 60, the content moving request requesting that the moving target contents should be moved (Step S20), the transmitting apparatus 50 starts the content moving process to be performed with the receiving apparatus 60. The transmitting apparatus 50 transmits the processing request to the receiving apparatus 60 to request that the authentication and key exchange process should be performed (Step S21) and starts the authentication and key exchange process to be performed with the receiving apparatus 60 (Step S22). After that, when the authentication and key exchange process has been completed and the transaction has been established between the transmitting apparatus 50 and the receiving apparatus 60, the transmitting apparatus 50 stores therein the correspondence relationship between the moving target contents and the transaction by storing therein at least the identifier of the moving target contents and the identifier of the transaction as shown in FIGS. 6 and 7 (Step S23). Subsequently, when the transmitting apparatus 50 transmits one of the partial contents contained in the moving target contents (No at Step S24), the transmitting apparatus 50 identifies the copy control information attached to the partial content serving as the transmission target (Step S25) and judges whether it is necessary to perform an encryption process (Step S26). For example, in the case where the copy control information indicates “No more copies”, the transmitting apparatus 50 judges that it is necessary to perform an encryption process, whereas in the case where the copy control information indicates “Copy free”, the transmitting apparatus 50 judges that it is not necessary to perform an encryption process.

In the case where the transmitting apparatus 50 has judged that it is not necessary to perform an encryption process (No at Step S26), the transmitting apparatus 50 judges whether the partial content serving as the transmission target is the second or later partial content within in the moving target contents (Step S27). In the case where the result of the judging process is in the affirmative (Yes at Step S27), the transmitting apparatus 50 starts the counting process to count the progress amount indicating the progress of the transmission (Step S28), and transmits the partial content serving as the transmission target to the receiving apparatus 60, without encrypting the partial content (Step S29). On the contrary, in the case where the partial content serving as the transmission target is the first partial content within the moving target contents (No at Step S27), the transmitting apparatus 50 proceeds to Step S29 without performing the process at Step S28.

In the case where the transmitting apparatus 50 has judged at Step S26 that it is necessary to perform an encryption process (Yes at Step S26), the transmitting apparatus 50 further judges whether the progress amount has exceeded the threshold value (Step S30). In the case where the result of the judging process is in the affirmative (Yes at Step S30), the transmitting apparatus 50 then judges whether the duplication flag is ON (Step S31). In the case where the result of the judging process is in the negative (No at Step S31), the transmitting apparatus 50 turns the duplication flag ON (Step S32). After generating the information used in the right-to-use moving process for the content that has been transmitted in the current transaction and storing therein the generated information, the transmitting apparatus 50 performs the right-to-use moving process with the receiving apparatus 60 (Step S33). After that, the transmitting apparatus 50 transmits the establishing request to the receiving apparatus 60 to request that a new transaction should be established (Step S34). Subsequently, the process returns to Step S21, and the transmitting apparatus 50 performs the process to establish the new transaction between the transmitting apparatus 50 and the receiving apparatus 60.

On the contrary, in the case where the transmitting apparatus 50 has judged at Step S31 that the duplication flag is ON (Yes at Step S31), the transmitting apparatus 50 makes a duplicate of a portion of such a partial content that is positioned before the partial content serving as the transmission target and that does not need to be encrypted (Step S35). After that, the transmitting apparatus 50 turns the duplication flag OFF (Step S36) and resets the threshold value (Step S37). Subsequently, the transmitting apparatus 50 transmits the partial content to the receiving apparatus 60 (Step S38).

On the other hand, in the case where the transmitting apparatus 50 has judged at Step S30 that the progress amount has not exceeded the threshold value (No at Step S30), the transmitting apparatus 50 encrypts the partial content serving as the transmission target (Step S39) and transmits the encrypted partial content to the receiving apparatus 60 (Step S40).

The transmitting apparatus 50 repeats the processes described above until the transmission of the entirety of the moving target contents has been completed. When the transmission of the entirety of the moving target contents has been completed (Yes at Step S24), the transmitting apparatus 50 generates the information used in the right-to-use moving process for the content that has been transmitted in the current transaction and stores the generated information therein. After that, the transmitting apparatus 50 performs the right-to-use moving process with the receiving apparatus 60 (Step S41) and thus completes the content moving process.

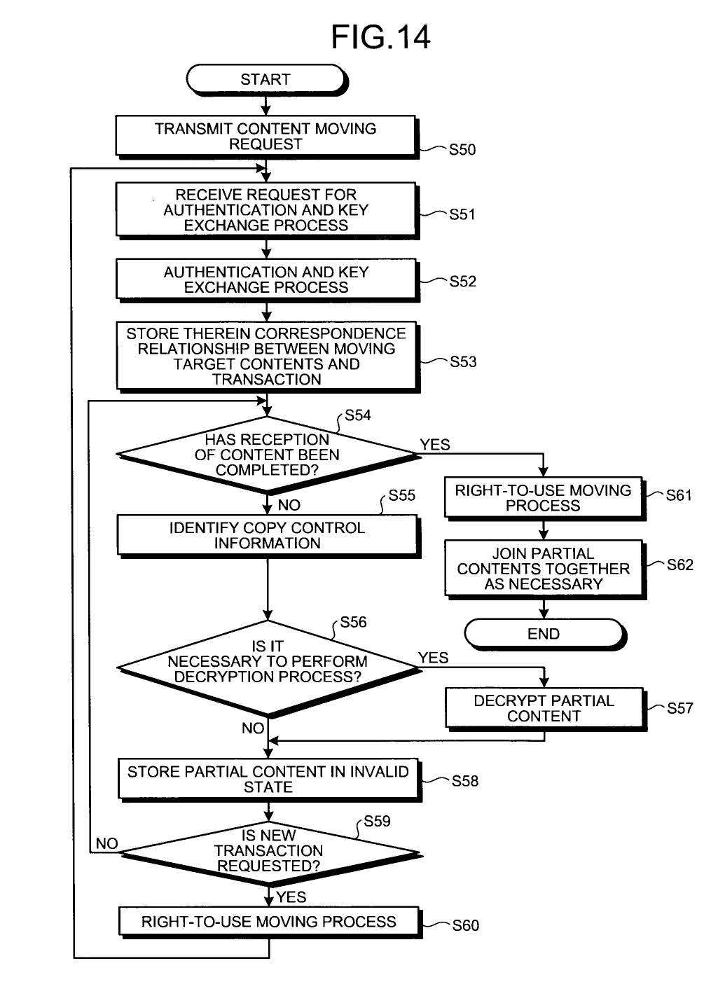

Next, a detailed procedure in the process performed by the receiving apparatus 60 according to the present embodiment during the content moving process described above will be explained, with reference to FIG. 14. First, the receiving apparatus 60 transmits the content moving request to the transmitting apparatus 50 to request that the moving target contents should be moved (Step S50) and starts the content moving process to be performed with the transmitting apparatus 50. When the receiving apparatus 60 has received the processing request requesting that the authentication and key exchange process should be performed from the transmitting apparatus 50 (Step S51), the receiving apparatus 60 starts the authentication and key exchange process to be performed with the transmitting apparatus 50 (Step S52). After that, when the authentication and key exchange process has been completed and the transaction has been established between the receiving apparatus 60 and the transmitting apparatus 50, the receiving apparatus 60 stores therein the correspondence relationship between the moving target contents and the transaction by storing therein at least the identifier of the moving target contents and the identifier of the transaction as shown in FIGS. 6 and 7 (Step S53). Subsequently, when the receiving apparatus 60 has received one of the partial contents contained in the moving target contents (Yes at Step S54), the receiving apparatus 60 identifies the copy control information attached to the partial content (Step S55) and judges whether it is necessary to perform a decryption process (Step S56). For example, in the case where the copy control information indicates “No more copies”, the receiving apparatus 60 judges that it is necessary to perform a decryption process, whereas in the case where the copy control information indicates “Copy free”, the receiving apparatus 60 judges that it is not necessary to perform a decryption process.

In the case where the result of the judging process is in the affirmative (Yes at Step S56), the receiving apparatus 60 decrypts the partial content (Step S57), stores therein the decrypted partial content in an invalid state (Step S58), and proceeds to Step S59. On the contrary, in the case where the result of the judging process at Step S56 is in the negative (No at Step S56), the receiving apparatus 60 performs the process at Step S58 without performing the process at Step S57. After that, the receiving apparatus 60 proceeds to Step S59.

At Step S59, the receiving apparatus 60 judges whether an establishing request requesting that a new transaction should be established has been received from the transmitting apparatus 50. In the case where the result of the judging process is in the affirmative (Yes at Step S59), the receiving apparatus 60 generates the information used in the right-to-use moving process for the content that has been received in the transaction that immediately precedes the newly established transaction and stores the generated information therein. After that, the receiving apparatus 60 performs the right-to-use moving process with the transmitting apparatus 50 (Step S60). Subsequently, the receiving apparatus 60 returns to Step S51 and performs the process to establish the new transaction between the receiving apparatus 60 and the transmitting apparatus 50. On the contrary, in the case where the receiving apparatus 60 has not received any establishing request requesting that a new transaction should be established (No at Step S59), the receiving apparatus 60 returns to Step S54 without having any new transaction established. In the case where the reception of the entirety of the moving target contents has not been completed (No at Step S54), the receiving apparatus 60 performs the processes at Step S55 and thereafter.

The receiving apparatus 60 repeats the processes described above until the reception of the entirety of the moving target contents has been completed. When the reception of the entirety of the moving target contents has been completed (Yes at Step S54), the receiving apparatus 60 generates the information used in the right-to-use moving process for the content that has been received in the current transaction and stores the generated information therein. After that, the receiving apparatus 60 performs the right-to-use moving process with the transmitting apparatus 50 (Step S61). Subsequently, the receiving apparatus 60 refers to the content management information and performs the content joining process described above, as necessary. Thus, the receiving apparatus 60 has completed the content moving process (Step S62).

As explained above, according to the present embodiment, while the contents are moved from the transmitting apparatus to the receiving apparatus, in the case where the progress amount indicating the progress of the transmitting and receiving process since the start of the transmission of the part that is transferred without being encrypted has exceeded the threshold value, and also, the part that is transferred after being encrypted has now become the transmission target, the duplicate of a portion of the part that is transferred without being encrypted is made and transmitted. After that, the received contents are joined together after one of the duplicated portions contained in the contents is deleted. With this arrangement, even if the situation arises where the shared key is invalidated, it is possible to move the contents from the transmitting apparatus to the receiving apparatus in a complete manner. In particular, with respect to the second partial content that is transmitted in the transaction different from the transaction in which the first partial content that immediately precedes the second partial content has been transmitted, in the case where the system is configured in such a manner that the start position of the second partial content needs to set to a start position that is recognizable instead of the actual start position, a conventional receiving apparatus has a possibility of missing the part from the actual start position to the recognizable start position of the second partial content. However, according to the present embodiment, the duplicate of the portion that contains the part that may be missing and of which the copyright does not have to be protected is made. Thus, it is possible to move the contents from the transmitting apparatus to the receiving apparatus in a complete manner without missing any part thereof, while keeping the copyright protected.

In the embodiment described above, an arrangement is acceptable in which the various types of computer programs executed by the transmitting apparatus 50 are stored in a computer connected to a network such as the Internet and provided as being downloaded via the network. Another arrangement is acceptable in which the various types of programs are provided as being recorded on a computer-readable recording medium such as a Compact Disk Read-Only Memory (CD-ROM), a Flexible Disk (FD), a Compact Disk Recordable (CD-R), a Digital Versatile Disk (DVD) or the like, in a file that is in an installable format or in an executable format. The same applies to the various types of computer programs executed by the receiving apparatus 60.

In FIG. 1, only one transmitting apparatus 50 and one receiving apparatus 60 are shown; however, the content transmitting and receiving system according to the present embodiment may include a plurality of transmitting apparatuses 50 and/or a plurality of receiving apparatuses 60. Also, the content transmitting and receiving system may have one or more apparatuses other than the transmitting apparatus 50 and the receiving apparatus 60 connected thereto via the network 70.

In the embodiment described above, another arrangement is acceptable in which the transmitting apparatus 50 does not have the function of the counter processing unit 504, and the copy control information processing unit 503 does not have the function of requesting a new transaction according to the progress amount and the copy control information, while the receiving apparatus 60 is configured so as to have these functions. In other words, it is acceptable to configure the counter processing unit 604 included in the receiving apparatus 60 so as to have the function of the counter processing unit 504 included in the transmitting apparatus 50 and to configure the copy control information processing unit 603 so as to have the function of the copy control information processing unit 503. In this situation, when the reception of “digital data of which the copyright does not have to be protected”, e.g., a content to which the copy control information “Copy free” is attached (i.e., the partial content C2 in the example above) has started, the copy control information processing unit 603 requests the counter processing unit 604 to start the counting process to count the progress amount indicating the progress of the reception. After that, in the case where the copy control information processing unit 603 has detected “digital data of which the copyright should be protected”, e.g., a content to which the copy control information “No more copies” is attached (i.e., the partial content C3 in the example above), and also, the copy control information processing unit 603 has been notified by the counter processing unit 604 that the progress amount indicating the progress of the reception has exceeded the threshold value, the copy control information processing unit 603 requests the transaction/content managing unit 602 to establish a new transaction. When having been requested by the copy control information processing unit 603 to start the counting process, the counter processing unit 604 counts the progress amount indicating the progress of the reception and, in the case where the progress amount has exceeded the threshold value, the counter processing unit 604 notifies the copy control information processing unit 603. The progress amount indicating the progress of the reception is expressed by, for example, how much time has been spent in performing the reception process. As explained above, the threshold value is specified as a value that is equal to or shorter than a predetermined period of time (e.g., two hours) between the time at which the receiving apparatus 60 stops using the shared key and the time at which the receiving apparatus 60 invalidates the shared key.

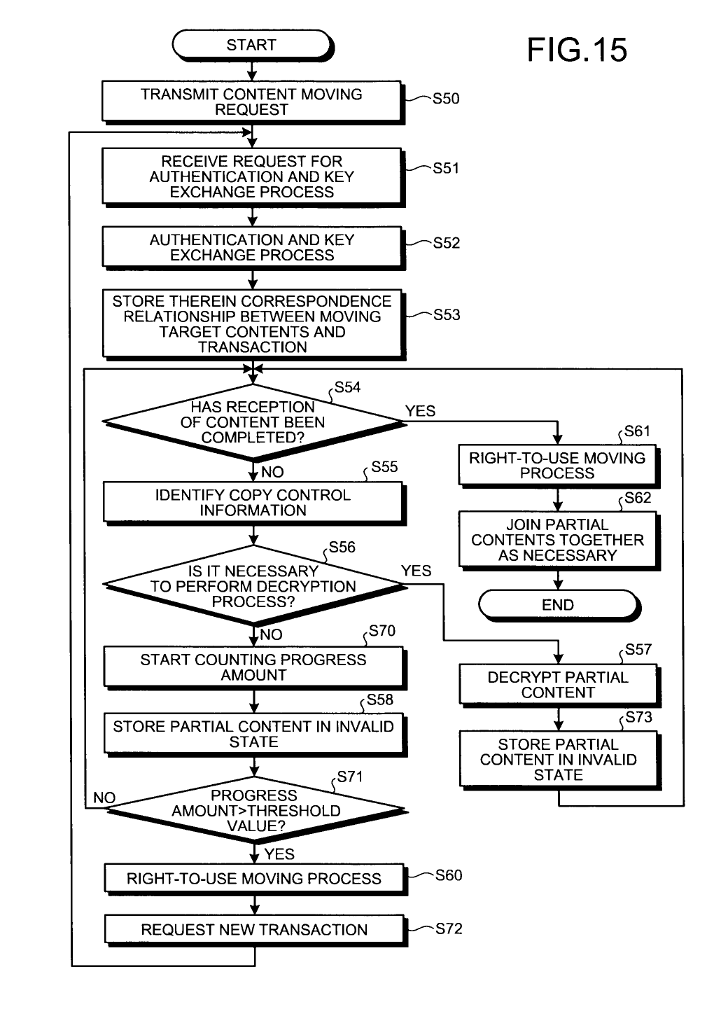

FIG. 15 is a flowchart of a procedure in the process performed by the receiving apparatus 60 according to the present modification example. The processes performed at Steps S50 through S56 are the same as those according to the embodiment described above. In the case where the result of the judging process at Step S56 is in the negative (No at Step S56), the receiving apparatus 60 starts counting the progress amount indicating the progress of the reception (Step S70), and performs the process at Step S58 in the same manner as described above. After that, the receiving apparatus 60 judges whether the progress amount has exceeded the threshold value (Step S71). In the case where the result of the judging process is in the affirmative (Yes at Step S71), the receiving apparatus 60 generates the information used in the right-to-use moving process in the current transaction and stores the generated information in an external storage device or a storage device. After that, the receiving apparatus 60 performs the right-to-use moving process with the transmitting apparatus 50 (Step S60). Subsequently, the receiving apparatus 60 transmits an establishing request to the transmitting apparatus 50 to request that a new transaction should be established (Step S72), and the process returns to Step S51. On the contrary, in the case where the result of the judging process at Step S56 is in the affirmative (Yes at Step S56), the receiving apparatus 60 performs the process at Step S57 and stores the partial content therein while the partial content is in an invalid state, in the same manner as at Step S58 (Step S73). After that, the process returns to Step S53. On the other hand, in the case where the result of the judging process at Step S71 is in the negative (No at Step S71), the receiving apparatus 60 does not request that a new transaction should be established. In the case where the reception of the entirety of the moving target contents has not been completed yet (No at Step S54), the receiving apparatus 60 performs the processes at Step S55 and thereafter. The processes thereafter are the same as those explained in the embodiment above.

On the other hand, when the transmitting apparatus 50 has received an establishing request requesting that a new transaction should be established from the receiving apparatus 60, the transmitting apparatus 50 transmits a processing request to the receiving apparatus 60 to request that an authentication and key exchange process should be performed and starts the authentication and key exchange process to be performed between the transmitting apparatus 50 and the receiving apparatus 60.

With the configuration described above also, it is possible to move the contents from the transmitting apparatus to the receiving apparatus in a complete manner even in the situation where the shared key is invalidated.

In the configuration described above, to request the transaction/content managing unit 602 to establish a new transaction between the receiving apparatus 60 and the transmitting apparatus 50 and to request the authentication/key exchange processing unit 601 to delete the shared key, an arrangement is acceptable in which the counter processing unit 604 counts the progress amount since the shared key stops being used, i.e., the progress amount since the reception of the partial content C2 is started, so as to use one threshold value for both of these requests. Another arrangement is acceptable in which mutually different threshold values are used for these requests, respectively. Yet another arrangement is acceptable in which two separate counter processing units are provided for these requests, respectively.

Yet another arrangement is acceptable in which both of the transmitting apparatus 50 and the receiving apparatus 60 have the function of counting the progress amount and the function of requesting that a new transaction should be established according to the progress amount and the copy control information. In this situation, it is possible to have an arrangement in which, in the case where one of the apparatuses has received an establishing request requesting that a new transaction should be established from the other apparatuses, the one of the apparatuses performs the process to establish the new transaction between those apparatuses without having to transmit the establishing request to the other apparatus.

In the embodiment and the modification example descried above, the progress amount indicating the progress of the transmission or the reception may be expressed by, for example, the amount of data that has been transmitted or received. In this situation, the threshold value is specified as a predetermined data amount.

In addition, in the embodiment described above, the threshold value is specified as a predetermined period of time or a predetermined data amount; however, the present invention is not limited to this example. It is acceptable to adaptively change the threshold value according to, for example, the transfer speed.

Further, in the embodiment example described above, the content moving request is transmitted from the receiving apparatus 60 to the transmitting apparatus 50; however, another arrangement is acceptable in which the content moving request is transmitted from the transmitting apparatus 50 to the receiving apparatus 60.

Furthermore, in the embodiment example described above, the processing request to request that the authentication and key exchange process should be performed is transmitted from the transmitting apparatus 50 to the receiving apparatus 60; however, another arrangement is acceptable in which the processing request is transmitted from the receiving apparatus 60 to the transmitting apparatus 50.

In the embodiment described above, because the copyright of the partial content C2 does not have to be protected, another arrangement is acceptable in which the receiving apparatus 60 stores therein the partial content C2 in a valid state when having received the partial content C2, regardless of whether the right-to-use moving process has been performed.

In the embodiment described above, as for the moving target contents C shown in FIG. 2, the moving of the moving target contents is completed when the moving of the partial content C3 is completed, and no other new transaction is established; however, in the case where the moving target contents C contain another partial content to which the copy control information “Copy free” is attached and that is to be transferred without being encrypted immediately after the partial content C3 is transferred, the progress amount indicating the progress since the transmission of the partial content is started is counted, in the same manner as described above. In the case where the progress amount has exceeded the threshold value, and also, a part that is to be transferred after being encrypted has been detected, another new transaction is further established so that the same processes as described above are repeated. In other words, even if the transmission of the moving target contents is performed while being distributed in three or more transactions, it is possible to move the contents from the transmitting apparatus to the receiving apparatus in a complete manner, in the situation where the shared key is invalidated.

In the embodiment described above, the request requesting that the new transaction E should be established is made by using the transaction D; however, it is acceptable to make the request by using another connection. Further, the new transaction may use Hyper Text Transfer protocol (HTTP) persistent connections. The new transaction may use the same connection as the transaction D or a different connection.

In the embodiment described above, in the case where the information used in the right-to-use moving process has become no longer necessary, the transmitting apparatus 50 and the receiving apparatus 60 may delete the information from the external storage device or the storage device.

In the embodiment described above, the process to generate the information used in the right-to-use moving process and the right-to-use moving process are performed consecutively; however, these processes do not have to be performed consecutively as long as they are performed before the shared key is invalidated and as long as the information generating process is performed before the right-to-use moving process. Further, the process to generate the information used in the right-to-use moving process in the transaction D need to be performed before the shared key K1 is invalidated in the receiving apparatus 60. Thus, if the shared key K1 has not been invalidated, it is acceptable to perform the information generating process immediately after the authentication and key exchange process is performed or after the request that the new transaction E should be established is made. Furthermore, the right-to-use moving process in the transaction D and the right-to-use moving process in the new transaction E may be performed any time before the content joining process is performed by the receiving apparatus 60.

In the description of the embodiment above, the partial contents to each of which the copy control information “No more copies” or the copy control information “Copy free” is attached are explained; however, the present invention is not limited to these examples. It is possible to apply the present invention to partial contents to each of which the copy control information “Copy one generation” or the copy control information “Copy free” is attached.

In the embodiment descried above, when the duplicate of a portion of the partial content C2 is made and transmitted, the transmitting apparatus 50 transmits, in the new transaction E, the portion of the partial content C2 to the receiving apparatus 60, without encrypting the portion. However, the present invention is not limited to this example. Another arrangement is acceptable in which the transmitting apparatus 50 encrypts, just like the partial content C3, the portion of the partial content C2 with the shared key K2 that is shared with the receiving apparatus 60 and transmits the encrypted portion to the receiving apparatus 60 in the new transaction E.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A transmitting apparatus that transmits a content containing element data in units of groups to a receiving apparatus, the transmitting apparatus comprising:
an encrypting unit that encrypts a first portion and a third portion, respectively, the content containing at least, in a stated order, the first portion that is encrypted with a shared key shared between the transmitting apparatus and the receiving apparatus, a second portion that is not encrypted, and the third portion that is encrypted with the shared key; and
a transmitting unit that sequentially transmits the encrypted first portion, the second portion, and the encrypted third portion, wherein
the transmitting unit sequentially transmits sequentially transmits the encrypted first portion, the second portion, then a fourth portion and the encrypted third portion to the receiving apparatus, the fourth portion containing at least element data that belongs to a last group in the second portion, when the encrypted third portion has become a transmission target after transmitting the second portion and there is a possibility that the shared key stored in the receiving apparatus is invalidated when the encrypted third portion is received.

2. The apparatus according to claim 1, further comprising:
an establishing unit that performs an establishing process to establish a transaction between the transmitting apparatus and the receiving apparatus; and
a key exchange processing unit that performs a key exchange process to share the shared key with the receiving apparatus in the transaction, wherein
the encrypting unit encrypts the firsts portion with the shared key, and
the transmitting unit sequentially transmits the encrypted first portion and the second portion to the receiving apparatus in the transaction.

3. The apparatus according to claim 2, wherein
the establishing unit performs an establishing process to establish a new transaction between the transmitting apparatus and the receiving apparatus, when the encrypted third portion has become a transmission target, and there is a possibility that the shared key stored in the receiving apparatus is invalidated when the encrypted third portion is received,
the key exchange processing unit performs a key exchange process to share a new shared key with the receiving apparatus in the new transaction,
the encrypting unit encrypts the third portion with the new shared key, and
the transmitting unit sequentially transmits the fourth portion and the encrypted third portion to the receiving apparatus in the new transaction.

4. The apparatus according to claim 1, further comprising a counting unit that, after the content starts being transmitted, counts a progress amount indicating a progress of the transmission of the second portion while using a start of the transmission of the second portion as a trigger, wherein
the transmitting unit sequentially transmits the encrypted first portion, the second portion, then the fourth portion and the encrypted third portion to the receiving apparatus, when the encrypted third portion has become a transmission target, and the counted progress amount has exceeded a threshold value.

5. The apparatus according to claim 4, wherein
pieces of control information each indicating whether copying is restricted is attached to the first portion, the second portion, and the third portion, respectively,
the transmitting apparatus includes a control information judging unit that judges whether a transmission target needs to be encrypted by referring to the piece of copy control information attached to the transmission target, when at least one of the first portion, the second portion, and the encrypted third portion has become the transmission target,
the encrypting unit encrypts the first portion when the control information judging unit has judged that the first portion needs to be encrypted, and the encrypting unit encrypts the third portion when the control information judging unit has judged that the third portion needs to be encrypted, and
the transmitting unit sequentially transmits the encrypted first portion, the second portion, then the fourth portion and the encrypted third portion to the receiving apparatus, when the control information judging unit has judged that the third portion needs to be encrypted, and the counted progress amount has exceeded the threshold value.

6. The apparatus according to claim 2, further comprising:
a first storage unit that stores the content;
a request receiving unit that receives, from the receiving apparatus, a moving request requesting that a right to use for the content is moved; and
a right-to-use moving processing unit that invalidates the right to use for the content stored in the first storage unit and transmits a permission to validate the right to use for the content to the receiving apparatus, when the request receiving unit has received the moving request.

7. The apparatus according to claim 6, further comprising a second storage unit that stores a correspondence relationship between the content and the transaction in which the content is transmitted, wherein
the request receiving unit receives, from the receiving apparatus, the moving request requesting that the right to use for the content is moved in correspondence with the transaction, and
the right-to-use moving processing unit invalidates the right to use for all or a part of the content that is stored in the first storage unit and of which the correspondence relationship with the transaction is stored in the second storage unit, and transmits a permission to validate the right to use for all or a part of the content to the receiving apparatus, when the request receiving unit has received the moving request from the receiving apparatus.

8. The apparatus according to claim 3, wherein the establishing unit performs the establishing process to establish a new transaction, when the encrypted third portion has become a transmission target, and the receiving apparatus has requested that the new transaction is established.

9. The apparatus according to claim 2, wherein the counting unit counts, as the progress amount, a transmission time period spent in transmitting the second portion or a data amount of the second portion.

10. The apparatus according to claim 1, wherein
the content is data in an MPEG 2 format,
the element data is one of an I Picture, a P Picture, and a B Picture, whereas a plurality of pictures starting with an I picture belong to each of the groups, and
the transmitting unit sequentially transmits the encrypted first portion, the second portion, then the fourth portion and the encrypted third portion to the receiving apparatus, the fourth portion containing at least a group of pictures starting with a picture positioned at an end of the second portion and through a first I picture from the end of the second portion, when the encrypted third portion has become a transmission target after the second portion has been transmitted, and there is a possibility that the shared key stored in the receiving apparatus is invalidated when the encrypted third portion is received.

11. A receiving apparatus that receives a content containing element data in units of groups from a transmitting apparatus, the receiving apparatus comprising:
a receiving unit that receives a fourth portion and a third portion that is encrypted sequentially from the transmitting apparatus, when there is a possibility that the shared key is invalidated after receiving a first portion that is encrypted and a second portion sequentially from the transmitting apparatus, the content containing at least, in a stated order, the first portion that is encrypted with a shared key shared between the receiving apparatus and the transmitting apparatus, the second portion that is not encrypted, the third portion that is encrypted with the shared key and the fourth portion containing element data that belongs to a last group in the second portion;
a decrypting unit that decrypts the encrypted first portion and the encrypted third portion, respectively; and
a joining unit that joins the second portion and the third portion together after deleting one of the fourth portion containing the element data that belongs to the last group in the received second portion and the fourth portion that has been received after the second portion was received.

12. The apparatus according to claim 11, further comprising:
an establishing unit that performs an establishing process to establish a transaction between the receiving apparatus and the transmitting apparatus; and
a key exchange processing unit that performs a key exchange process to share the shared key with the transmitting apparatus in the transaction, wherein
the receiving unit sequentially receives the encrypted first portion and the second portion from the transmitting apparatus in the transaction, and
the decrypting unit decrypts the firsts portion with the shared key.

13. The apparatus according to claim 12, wherein
the establishing unit performs an establishing process to establish a new transaction between the transmitting apparatus and the receiving apparatus, when there is a possibility that the shared key is invalidated after the second portion has been transmitted,
the key exchange processing unit performs a key exchange process to share a new shared key with the transmitting apparatus in the new transaction,
the receiving unit sequentially receives the fourth portion and the encrypted third portion from the transmitting apparatus in the new transaction, and
the decrypting unit decrypts the third portion with the new shared key.

14. The apparatus according to claim 13, further comprising a first counting unit that, after the content starts being received, counts a progress amount indicating a progress of the reception of the second portion while using a start of the reception of the second portion as a trigger, wherein
the establishing unit performs the establishing process to establish the new transaction, when the encrypted third portion has become a reception target after the second portion has been received, and the counted progress amount has exceeded a threshold value.

15. The apparatus according to claim 14, wherein
pieces of control information each indicating whether copying is restricted is attached to the first portion, the second portion, and the third portion, respectively,
the receiving apparatus includes a control information judging unit that judges whether a reception target needs to be decrypted by referring to the piece of copy control information attached to the reception target, when at least one of the encrypted first portion, the second portion, and the encrypted third portion has become the reception target,
the decrypting unit decrypts the encrypted first portion and the encrypted third portion according to a result of the judging process performed by the control information judging unit, and
the establishing unit performs the establishing process to establish the new transaction, when the control information judging unit has judged that the encrypted third portion that has become a reception target after the second portion was received needs to be decrypted, and the counted progress amount has exceeded the threshold value.

16. The apparatus according to claim 13, wherein the establishing unit performs the establishing process to establish a new transaction, when the transmitting apparatus has requested, after the second portion has been received, that the new transaction is established.

17. The apparatus according to claim 12, further comprising:
a storage unit that stores the content received from the transmitting apparatus;
a request transmitting unit that transmits, to the transmitting apparatus, a moving request requesting that a right to use for the content is moved;
a permission receiving unit that receives, from the transmitting apparatus, a permission to validate the right to use for the content in response to the moving request; and
a right-to-use moving processing unit that validates the right to use for the content stored in the storage unit, when the permission receiving unit has received the permission.

18. The apparatus according to claim 17, wherein
the request transmitting unit transmits, to the transmitting apparatus, the moving request requesting that the right to use for the content is moved in correspondence with the transaction, and
the right-to-use moving processing unit invalidates the right to use for all or a part of the content stored in the storage unit in correspondence with the transaction, when the permission receiving unit has received the permission.

19. The apparatus according to claim 11, further comprising:
a second counting unit that counts a period of time that has elapsed since the shared key stops being used; and
an invalidating unit that invalidates the shared key when the counted elapsed period of time has exceeded a predetermined length of time.

20. The apparatus according to claim 14, wherein the counting unit counts, as the progress amount, a reception time period that has been spent in receiving the second portion or a data amount of the second portion.

21. A content transmitting and receiving system in which a content containing element data in units of groups is transmitted from a transmitting apparatus to a receiving apparatus, the content transmitting and receiving system comprising:
a counting unit that counts a progress amount indicating a progress of the transmission of a second portion or a progress of the reception of a second portion, the content containing at least, in a stated order, a first portion that is encrypted with a shared key shared between the receiving apparatus and the transmitting apparatus, the second portion that is not encrypted, and a third portion that is encrypted with the shared key, wherein
the transmitting apparatus includes
an encrypting unit that encrypts the first portion and the third portion, and
a transmitting unit that sequentially transmits the encrypted first portion, the second portion, and the encrypted third portion,
the transmitting unit sequentially transmits the first portion, the second portion, a fourth portion and the encrypted third portion to the receiving apparatus, the fourth portion containing element data that belongs to a last group in the second portion, when the encrypted third portion has become a transmission target after transmitting the second portion, and the counted progress amount has exceeded a threshold value,
the receiving apparatus includes
a receiving unit that receives the fourth portion and the encrypted third portion sequentially from the transmitting apparatus, the fourth portion containing the element data that belongs to the last group in the second portion, when the counted progress amount has exceeded the threshold value after the encrypted first portion and the second portion have sequentially been received from the transmitting apparatus;
a decrypting unit that decrypts the encrypted first portion and the encrypted third portion, respectively, and
a joining unit that joins the second portion and the third portion together after deleting one of the fourth portion containing the element data that belongs to the last group in the received second portion and the fourth portion that has been received after the second portion was received.

22. A content transmitting method implemented in a transmitting apparatus that transmits a content containing element data in units of groups to a receiving apparatus, the method comprising:
encrypting a first portion and a third portion, respectively by the encrypting unit, the content containing at least, in a stated order, the first portion that is encrypted with a shared key shared between the transmitting apparatus and the receiving apparatus, the second portion that is not encrypted, and the third portion that is encrypted with the shared key, and the transmitting apparatus includes an encrypting unit and a transmitting unit;
transmitting sequentially the encrypted first portion, the second portion, and the encrypted third portion by the transmitting unit; and
transmitting sequentially the encrypted first portion, the second portion, then a fourth portion and the encrypted third portion to the receiving apparatus, the fourth portion containing at least element data that belongs to a last group in the second portion, when the encrypted third portion has become a transmission target after transmitting the second portion, and there is a possibility that the shared key stored in the receiving apparatus is invalidated when the encrypted third portion is received.

23. A content receiving method implemented in a receiving apparatus that receives a content containing element data in units of groups from a transmitting apparatus, the receiving apparatus includes a receiving unit, a decrypting unit, and a joining unit, the method comprising:
receiving a fourth portion and a third portion that is encrypted sequentially from the transmitting apparatus, when there is a possibility that the shared key is invalidated after receiving a first portion that is encrypted and a second portion sequentially from the transmitting apparatus, the content containing at least, in a stated order, the first portion that is encrypted with a shared key shared between the receiving apparatus and the transmitting apparatus, the second portion that is not encrypted, the third portion that is encrypted with the shared key and the fourth portion containing element data that belongs to a last group in the second portion;
decrypting the encrypted first portion and the encrypted third portion, respectively by the decrypting unit; and
joining the second portion and the third portion together by the joining unit after deleting one of the fourth portion containing the element data that belongs to the last group in the received second portion and the fourth portion that has been received after the second portion was received.

24. A computer program product having a computer readable medium including programmed instructions, when executed by a computer included in a transmitting apparatus that transmits a content containing element data in units of groups to a receiving apparatus, wherein the instructions cause the computer to perform:
encrypting a first portion and a third portion, respectively, the content containing at least, in a stated order, the first portion that is encrypted with a shared key shared between the transmitting apparatus and the receiving apparatus, a second portion that is not encrypted, and the third portion that is encrypted with the shared key;
transmitting sequentially the encrypted first portion, the second portion, and the encrypted third portion; and
transmitting sequentially the encrypted first portion, the second portion, a fourth portion and the encrypted third portion to the receiving apparatus, the fourth portion containing at least element data that belongs to a last group in the second portion, when the encrypted third portion has become a transmission target after transmitting the second portion, and there is a possibility that the shared key stored in the receiving apparatus is invalidated when the encrypted third portion is received.

25. A computer program product having a computer readable medium including programmed instructions, when executed by a computer included in a receiving apparatus that receives a content containing element data in units of groups from a transmitting apparatus, wherein the instructions cause the computer to perform:
receiving a fourth portion and a third portion that is encrypted sequentially from the transmitting apparatus, when there is a possibility that the shared key is invalidated after receiving a first portion that is encrypted and a second portion sequentially from the transmitting apparatus, the content containing at least, in a stated order, the first portion that is encrypted with a shared key shared between the receiving apparatus and the transmitting apparatus, the second portion that is not encrypted, the third portion that is encrypted with the shared key and the fourth portion containing element data that belongs to a last group in the second portion;
decrypting the encrypted first portion and the encrypted third portion, respectively; and
joining the second portion and the third portion together after deleting one of the fourth portion containing the element data that belongs to the last group in the received second portion and the fourth portion that has been received after the second portion was received.
